(19) United States
(12) Patent Application Publication
(10) Pub. No.: US 2015/0009104 A1
(43) Pub. Date: Jan. 8, 2015

(54) ORGANIC LIGHT-EMITTING DIODE (OLED) DISPLAY

(71) Applicant: Samsung Display Co., Ltd., Yongin-city (KR)

(72) Inventors: Jeong-Kyoo Kim, Yongin-city (KR); Hyung-Ryul Kang, Yongin-city (KR)

(73) Assignee: Samsung Display Co., Ltd., Yongin-city (KR)

(21) Appl. No.: 14/067,569

(22) Filed: Oct. 30, 2013

(30) Foreign Application Priority Data
Jul. 5, 2013 (KR) 10-2013-0079285

(51) Int. Cl. G09G 3/32

(52) U.S. Cl. CPC G09G 3/3225
USPC 345/76

(57) ABSTRACT

An organic light-emitting diode (OLED) display is disclosed. In one aspect, the OLED display includes a plurality of pixels arranged in a first direction and a second direction. Each of the pixels includes a first sub-pixel having a substantially isosceles triangle and a second sub-pixel having a substantially isosceles triangle shape, wherein the second sub-pixel is inverted with respect to the first sub-pixel. Each of the pixels also includes a third sub-pixel and a fourth sub-pixel each having a substantially right triangle shape, wherein the fourth sub-pixel is inverted with respect to the third sub-pixel. Two pixels adjacent to each other in the first direction are symmetric about an axis of symmetry that is parallel with the second direction, and two pixels adjacent to each other along the second direction are symmetric about an axis of symmetry that is parallel with the first direction.

### CROSS-REFERENCE TO RELATED APPLICATIONS

This application claims priority to and the benefit of Korean Patent Application No. 10-2013-0079285 filed in the Korean Intellectual Property Office on Jul. 5, 2013, the entire content of which is incorporated herein by reference.

### BACKGROUND

1. Field

The described technology generally relates to an organic light-emitting diode (OLED) display, and more particularly, to the shape of sub-pixels forming a pixel in an OLED display.

2. Description of the Related Technology

Display devices display images through the combination of light emitted from a plurality of pixels. Each pixel generally includes red, green, and blue sub-pixels, and a white sub-pixel can further be included.

In an OLED display, each sub-pixel is typically formed of a pixel circuit and an OLED which is controlled by the pixel circuit. The OLED generally includes an anode, a cathode, and an organic emission layer. Electrons and holes are combined with each other in the organic emission layer to thereby generate excitons, and when the excitons return to a ground state from an excited state, energy is generated, thereby emitting light.

### SUMMARY OF CERTAIN INVENTIVE ASPECTS

One inventive aspect is an OLED display that can improve the screen luminance and life-span characteristics thereof by increasing the size of light emission area of sub-pixels within a fixed-size pixel.

Another aspect is an OLED display including a plurality of pixels arranged along a first direction and a second direction. Each of the pixels includes a first sub-pixel formed in the shape of an isosceles triangle, a second sub-pixel formed in the shape of an isosceles triangle of which the bottom side and the vertex are opposite to those of the first sub-pixel, a third sub-pixel formed in the shape of a right triangle, and a fourth sub-pixel formed in the shape of a right triangle of which the bottom side and the vertex are opposite to those of the third sub-pixel.

The first sub-pixel and the second sub-pixel may be adjacent to each other in the first direction, and a pattern margin may be formed therebetween in a center portion of the pixel.

The third sub-pixel may be disposed on an external side of the first sub-pixel in the first direction, a pattern margin may be formed therebetween and the hypotenuse of the third sub-pixel may face the first sub-pixel. The fourth sub-pixel may be disposed on an external side of the second sub-pixel in the first direction, the pattern margin may be formed therebetween and the hypotenuse of the fourth sub-pixel may face the second sub-pixel.

Two pixels adjacent to each other in the first direction may be substantially symmetric with respect to an axis of symmetry that is substantially parallel to the second direction, and two pixels adjacent to each other in the second direction may be substantially symmetric with respect to an axis of symmetry that is substantially parallel to the first direction.

The sub-pixels may each respectively include pixel electrodes, organic emission layers, and common electrodes, and the pixel electrodes may be formed in substantially the same shape as the corresponding sub-pixel.

The first sub-pixel may face a first sub-pixel of an adjacent pixel which is adjacent in the second direction, and the organic emission layer may be commonly formed over the two first sub-pixels adjacent in the second direction.

The second sub-pixel may face a second sub-pixel of an adjacent pixel which is adjacent in the second direction, and the organic emission layer may be commonly formed over the two second sub-pixels adjacent each other in the second direction.

The third sub-pixel may face third sub-pixels of adjacent pixels which are adjacent in the first and second directions, and the organic emission layer may be commonly formed over four third sub-pixels adjacent to each other in the first and second directions.

The fourth sub-pixel may face fourth sub-pixels of adjacent pixels which are adjacent in the first and second directions, and the organic emission layer may be commonly formed over four fourth sub-pixels adjacent to each other along the first and second directions.

The pixel electrodes of adjacent sub-pixels between adjacent pixels may be separated by a gap that is smaller than the pattern margin.

The first sub-pixel and the second sub-pixel may have substantially the same shape and size, and the third sub-pixel and the fourth sub-pixel may have substantially the same shape and size. The size of the third sub-pixel may be about half of the size of the first sub-pixel.

One of the first sub-pixel and the second sub-pixel may be a blue sub-pixel and the other may be a white sub-pixel. One of the third sub-pixel and the fourth sub-pixel may be a green sub-pixel and the other may be a red sub-pixel.

### BRIEF DESCRIPTION OF THE DRAWINGS

The accompanying drawings, together with the specification, illustrate exemplary embodiments of the described technology, and, serve to explain the principles of the described technology.

FIG. 1 is a top plan view of pixels of an OLED display according to an exemplary embodiment.

FIG. 2 is a top plan view of one pixel among the pixels illustrated in FIG. 1.

FIG. 3 is an equivalent circuit diagram of one sub-pixel among the sub-pixels illustrated in FIG. 2.

FIG. 4 is a partially enlarged cross-sectional view of one sub-pixel of the sub-pixels illustrated in FIG. 2.

FIG. 5 is a schematic diagram provided for description of a deposition process of an organic emission layer using a pattern mask.

FIG. 6 is a top plan view of the pixel structure of FIG. 1 and the organic light emission layer.

FIG. 7 is a top plan view of a pixel structure of an OLED display according to a comparative example.

### DETAILED DESCRIPTION OF CERTAIN INVENTIVE EMBODIMENTS

When manufacturing an OLED display with a decreased screen size and/or an increased resolution, a minimum sized pattern margin is required between sub-pixels of the display. Accordingly, the area of the organic emission layers of the sub-pixels which contributes to the luminance of the sub-pixels is limited by the size of the pattern margin between the sub-pixels. Therefore, a decrease in screen size and/or an increase in resolution of the OLED display may result in a reduction of the luminance and life-span of the display.

The described technology will be described more fully hereinafter with reference to the accompanying drawings, in which exemplary embodiments of the described technology are shown. As those skilled in the art would realize, the described embodiments may be modified in various different ways, all without departing from the spirit or scope of the described technology.

In addition, unless explicitly described to the contrary, the word “comprise” and variations such as “comprises” or “comprising”, will be understood to imply the inclusion of stated elements but not the exclusion of any other elements. It will be understood that when an element such as a layer, film, region, or substrate is referred to as being “on” another element, it can be directly on the other element or intervening elements may also be present. Further, in the specification, the word “on” means positioning on or below an object portion, but is not limited to positioning on the upper side of the object portion based on the orientation of the device.

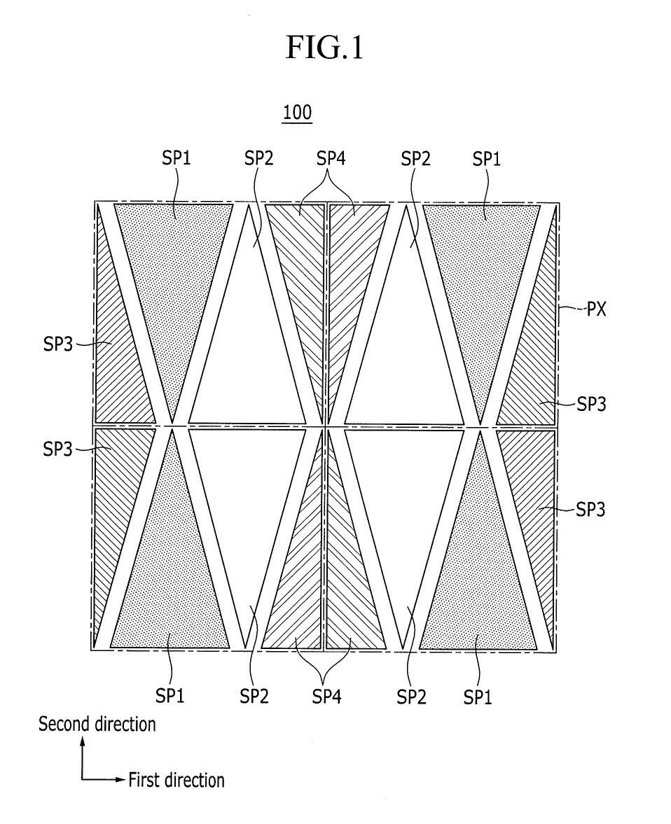

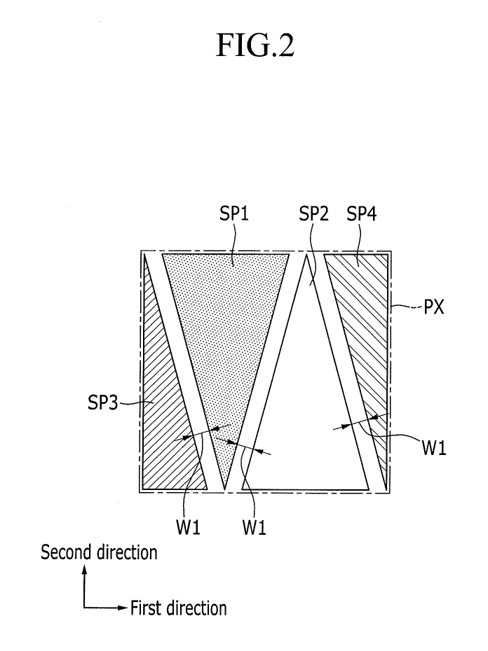

FIG. 1 is a top plan view of pixels of an organic light-emitting diode (OLED) display according to an exemplary embodiment, and FIG. 2 is a top plan view of one of the plurality of pixels shown in FIG. 1.

Referring to FIG. 1 and FIG. 2, an OLED display 100 includes a plurality of pixels PX arranged in a first direction and a second direction. Each pixel PX may be formed in the shape of a quadrangle, for example, a square. Each pixel PX is formed of first sub-pixels SP1, second sub-pixels SP2, third sub-pixels SP3, and fourth sub-pixels SP4, and the first to fourth sub-pixels SP1 to SP4 respectively emit light of different colors.

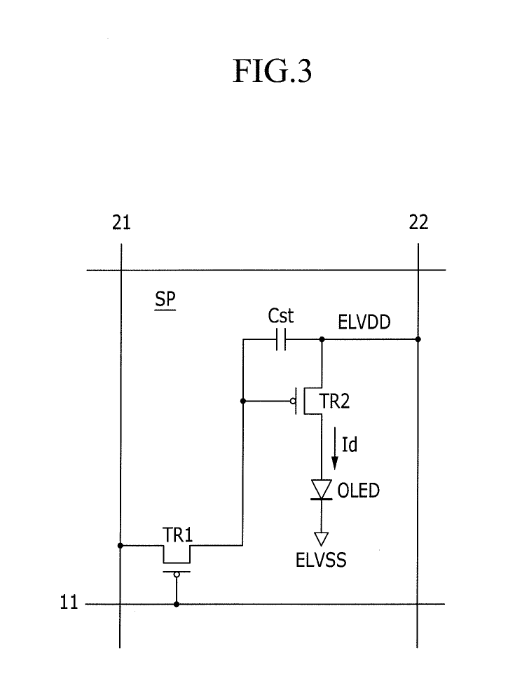

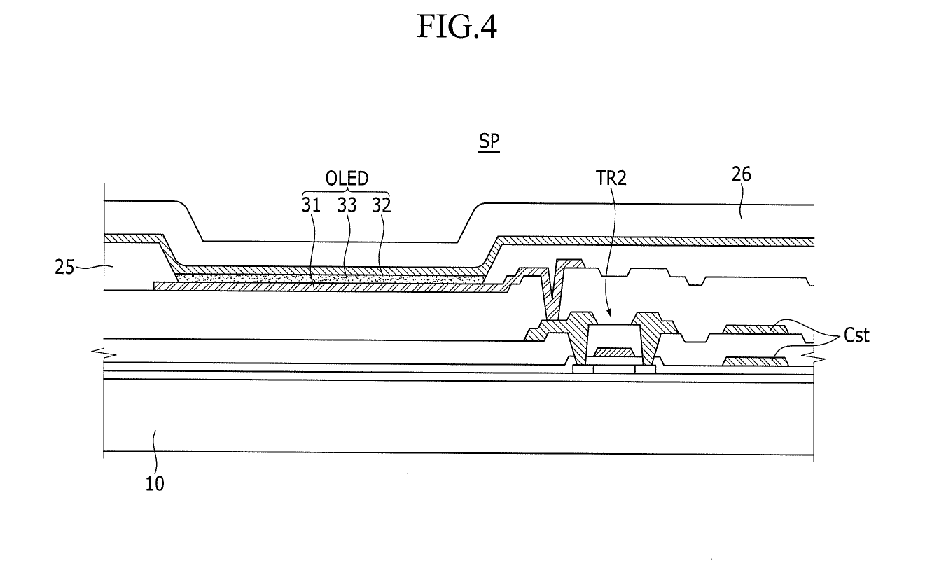

FIG. 3 and FIG. 4 are an equivalent circuit diagram and a partially enlarged cross-sectional view of one of the plurality of sub-pixels of FIG. 2. Excluding the planar shapes of the sub-pixels, the first to fourth sub-pixels respectively have substantially the same pixel circuit structure and substantially the same cross-sectional shape.

Referring to FIG. 3 and FIG. 4, each sub-pixel SP is connected with a plurality of signal lines 11, 21, and 22 formed on a substrate 10. The signal lines include a plurality of scan lines 11 transmitting scan signals (or, gate signals), a plurality of data lines 21 transmitting data signals, and a plurality of driving voltage lines 22 transmitting driving voltages.

The scan lines 11 are substantially parallel with a row direction, and the data lines 21 and the driving voltage lines 22 are substantially parallel with a column direction. Each sub-pixel SP includes a switching thin film transistor TR1, a driving thin film transistor TR2, a storage capacitor Cst, and an organic light-emitting diode OLED.

The switching thin film transistor TR1 includes a control terminal, an input terminal, and an output terminal. The control terminal is connected to the scan line 11, the input terminal is connected to the data line 21, and the output terminal is connected to the driving thin film transistor TR2. The switching thin film transistor TR1 transmits a data signal applied to the data line 21 to the driving thin film transistor TR2 in response to a scan signal applied to the scan line 11.

The driving thin film transistor TR2 also includes a control terminal, an input terminal, and an output terminal. The control terminal is connected to the switching thin film transistor TR1, the input terminal is connected to the driving voltage line 22, and the output terminal is connected to the OLED. The driving thin film transistor TR2 supplies an output current Id with a magnitude which varies depending on a voltage between the control terminal and the input terminal thereof.

The storage capacitor Cst is connected between the control terminal and the input terminal of the driving thin film transistor TR2. The storage capacitor Cst is charged with a data signal applied to the control terminal of the driving transistor TR2 and maintains the data signal even after the switching transistor TR1 is turned off.

The OLED includes a pixel electrode 31 connected to the output terminal of the driving thin film transistor TR2, a common electrode 32 connected to a common voltage ELVSS, and an organic emission layer 33 formed between the pixel electrode 31 and the common electrode 32. The OLED emits light with an intensity that varies depending on the output current Id of the driving thin film transistor TR2.

In the pixel circuit of FIG. 3, one sub-pixel SP includes two thin film transistors TR1 and TR2 and one capacitor Cst, but the described technology is not limited thereto. That is, in the OLED display 100, each sub-pixel SP may include three or more thin film transistors and two or more capacitors, and additional wires may be formed or existing wires may be omitted.

The switching thin film transistor TR1 and the driving thin film transistor TR2 may be n-channel field effect transistors or p-channel field effect transistors. In addition, the connections between the switching and driving thin film transistors TR1 and TR2, the storage capacitor Cst, and the OLED may be changed.

In the OLED, the pixel electrode 31 and the organic emission layer 33 are individually formed in each sub-pixel SP, and the common electrode 32 is formed over the entire display area. In FIG. 4, reference numeral 25 denotes a pixel defining layer that partitions the sub-pixel areas.

One of the pixel electrode 31 and the common electrode 32 is a hole injection electrode (i.e., an anode) and the other is an electron injection electrode (i.e., a cathode). A hole injection layer and a hole transfer layer may be provided between the anode and the organic emission layer 33, and an electron injection layer and an electron transfer layer may be provided between the cathode and the organic emission layer 33. Electrons and holes injected from the two electrodes are combined in the organic emission layer 33 and excitons are generated from the combination of the injected electrons and holes, and light is emitted when the excitons return to a ground state.

One of the pixel electrode 31 and the common electrode 32 may be formed of a metal reflective layer and the other may be formed of a semi-transmissive layer or a transparent conductive layer. Light emitted from the organic emission layer 33 is reflected by the metal reflective layer and then emitted to the environment through the semi-transmissive layer or the transparent conductive layer. When a semi-transmissive layer is employed, light emitted from the organic emission layer 33 is partially reflected to the reflective layer such that a resonance structure is formed.

A thin film encapsulation layer 26 is formed on the OLED. The thin film encapsulation layer 26 seals the OLED from the external environment which may contain moisture and oxygen. An encapsulation substrate may be provided in place of the thin film encapsulation layer 26.

When the OLED display is a front emission type and thus light emitted from the organic emission layer 33 is emitted through the common electrode 32, a touch screen panel and an optical film may be attached to an external surface of the thin film encapsulation layer 26. When the OLED display is a bottom emission type and the light emitted from the organic emission layer 33 is emitted through the pixel electrode 31, a touch screen panel and an optical film may be attached to an external surface of the substrate 10.

The color of light emitted from each of the first to fourth sub-pixels SP1 to SP4 correspond to the color of light emitted from the organic emission layer 33 of the corresponding sub-pixel. The organic emission layer 33 may be a red, green, blue, or white emission layer. In this case, the white emission layer may be formed by layering of red, green, and blue emission layers.

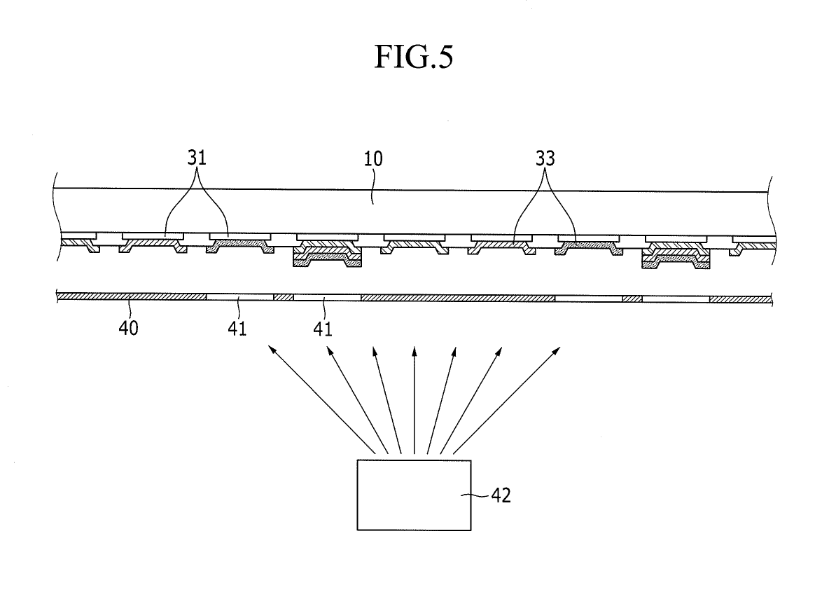

An organic emission layer 33 for each sub-pixel may be formed by a deposition method using a pattern mask. FIG. 5 is a schematic diagram for describing a deposition process using a pattern mask.

Referring to FIG. 5, a pattern mask 40 is a metal mask having a plurality of openings 41 formed therein, and is arranged below the substrate 10 in a deposition chamber. An organic material discharged from a deposition source 42 is passed through the openings 41 of the pattern mask 40 and then deposited on a pixel electrode 31 of a given sub-pixel such that the organic emission layer 33 is formed.

The pattern mask 40 may include three types of pattern masks that include a first pattern mask for forming red sub-pixels, a second pattern mask for forming green sub-pixels, and a third pattern mask for forming blue sub-pixels. In this case, each of the first to third pattern masks includes openings 41 corresponding to the white sub-pixel such that the red, green, and blue emission layers can be layered to form the white sub-pixel.

When an alignment error occurs between the substrate 10 and the pattern mask 40 during the above described deposition process, a deposition failure may occur wherein the organic emission layer 33 may be separated from the corresponding sub-pixel or may overlap another sub-pixel. Therefore, a predetermined distance, that is, a pattern margin is provided between the respective sub-pixels in the OLED display to thereby reduce the occurrence rate of deposition failure.

The OLED display 100 according to the present exemplary embodiment can substantially eliminate the pattern margin between the pixels based on the configuration of the pixel PX, and accordingly a light emission area of the pixels can be increased. The structure of the pixels PX will now be described.

Referring to FIG. 1 and FIG. 2, each of the first sub-pixels SP1 is formed in the shape of an isosceles triangle, and the bottom side and the vertex of the first sub-pixel SP1 are disposed facing each other along the second direction. Each of the second sub-pixels SP2 is formed in the shape of an isosceles triangle and the bottom side and the vertex thereof are opposite to those of the first sub-pixel SP1. Consequently, the second sub-pixel SP2 is inverted with respect to the first sub-pixel SP1. The lengths of the bottom sides of the first and second sub-pixels SP1 and SP2 are substantially equivalent to each other, and the first and second sub-pixels SP1 and SP2 have substantially the same vertex angle. That is the first and second sub-pixels SP1 and SP2 have substantially the same shape and size.

In some embodiments, each of the third sub-pixel SP3 and the fourth sub-pixel SP4 has a substantially right triangle shape. The fourth sub-pixel SP4 is located opposite to the third sub-pixel SP3. Consequently, the fourth sub-pixel SP4 is inverted with respect to the third sub-pixel SP3. The bottom sides of the third and fourth sub-pixels SP3 and SP4 may have substantially the same length, and the hypotenuse of each of the third fourth sub-pixels SP3 and SP4 may have substantially the same length. That is, the third fourth sub-pixels SP3 and SP4 may have substantially the same shape and size.

The first sub-pixels SP1 and the second sub-pixels SP2 are disposed adjacent to each other in the first direction and a pattern margin is formed therebetween in a center portion of the pixel PX. The third sub-pixels SP3 are disposed on the external sides of the first sub-pixels SP1 in the first direction, and a pattern margin is formed therebetween in the periphery area of the pixel PX. The fourth sub-pixels SP4 are disposed on the external sides of the second sub-pixels SP2 in the first direction, and a pattern margin is formed therebetween in the periphery area of the pixel PX.

The third sub-pixel SP3 faces the first sub-pixel SP1 along the hypotenuse thereof, and the fourth sub-pixel SP4 faces the second sub-pixel SP2 along the hypotenuse thereof. In FIG. 2, W1 denotes the width of the pattern margin. In one pixel PX, the pattern margins in the three locations may have substantially the same width.

The length of the bottom side of the third sub-pixel SP3 may be about half of the length of the bottom side of the first sub-pixel SP1. In addition, the height of the third sub-pixel SP3 may be substantially the same as the height of the first sub-pixel SP1. In this case, the area of the third sub-pixel SP3 is about half of the area of the first sub-pixel SP1. In addition, the area of the fourth sub-pixel SP4 is about half of the area of the second sub-pixel SP2.

One of the first and second sub-pixels SP1 and SP2 may be a blue sub-pixel and the other may be a white sub-pixel. One of the third and fourth sub-pixels SP3 and SP4 may be a green sub-pixel and the other may be a red sub-pixel.

In general, the luminous efficiency of a blue organic emission layer is lower than the luminous efficiency of red and green organic emission layers, and therefore the lower luminous efficiency can be compensated by increasing the light emission area of the blue sub-pixel. Unlike the sub-pixels that emit colored light, the white sub-pixel only can control the intensity of light. An OLED display 100 including a white sub-pixel can improve color expression and screen luminance in comparison to other OLED displays that do not include a white sub-pixel.

In the pixel shown in FIG. 2, the third, first, second, and fourth sub-pixels SP3, SP1, SP2, and SP4 are sequentially arranged along the first direction, and the height of each of the first to fourth sub-pixels SP1 to SP4 is substantially parallel to the second direction. The first direction and the second direction in FIG. 1 may be opposite to the first direction and the second direction in FIG. 2. That is, the structure of the pixel PX may be the same as the pixel of FIG. 1 and FIG. 2, rotated by 90 degrees in a clockwise or counter-clockwise direction.

The shapes of the above-stated first to fourth sub-pixels SP1 to SP4 correspond to the shape of a pixel electrode 31 (refer to FIG. 4) disposed in the corresponding sub-pixel.

Among the plurality of pixels PX, two pixels adjacent to each other in the first direction are substantially symmetric with respect to an axis of symmetry that is substantially parallel to the second direction. In addition, two pixels PX adjacent to each other in the second direction are substantially symmetric with respect to an axis of symmetry that is substantially parallel with the first direction. That is, two pixels PX adjacent to each other in the horizontal direction as illustrated in the drawings are substantially vertically symmetric and two pixels PX adjacent to each other in the vertical direction are substantially horizontally symmetric.

Thus, a first sub-pixel SP1 of a pixel PX faces a first sub-pixel SP1 of the adjacent pixel PX in the second direction and a second sub-pixel SP2 of the pixel PX also faces a second sub-pixel SP2 of the adjacent pixel PX in the second direction. A third sub-pixel SP3 of a pixel PX faces third sub-pixels SP3 of the adjacent pixels PX in the first and second directions and a fourth sub-pixel SP4 of the pixel PX also faces fourth sub-pixels SP4 of the adjacent pixels PX in the first and second directions.

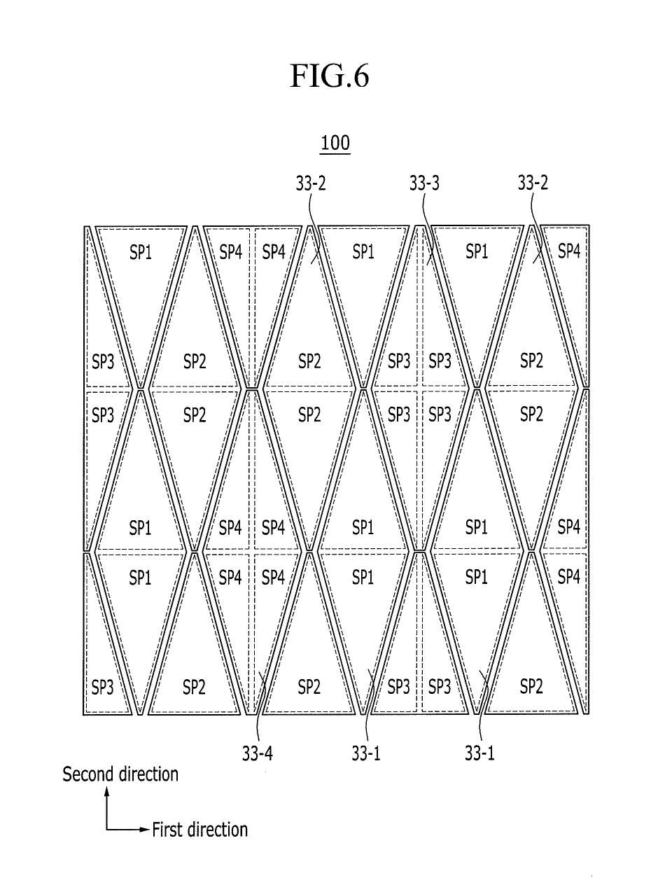

FIG. 6 is a top plan view of the pixel structure of FIG. 1, together with an organic emission layer.

Referring to FIG. 1 and FIG. 6, one organic emission layer is commonly formed over two first sub-pixels SP1 adjacent to each other in the second direction. That is, a pattern mask 40 (refer to FIG. 5) includes an opening 41 corresponding to two first sub-pixels SP1, and one organic emission layer 33-1 is substantially simultaneously formed on two pixel electrodes 31 through the opening 41. The organic emission layer 33-1 of the first sub-pixels SP1 may have a substantially rhombus shape.

Although the organic emission layer 33-1 is commonly formed over two first sub-pixels SP1, pixel electrodes 31 of the two first sub-pixels SP1 are separated from each other so that the two first sub-pixels SP1 may respectively emit light.

The organic emission layer 33-1 is formed over the two neighboring first sub-pixels SP1, and therefore a pattern margin used for substantially preventing a deposition failure may not be required between the two first sub-pixels SP1. Therefore, in some embodiments, there is no pattern margin between two neighboring first sub-pixels SP1, and there is only the minimum gap required to substantially prevent a short-circuit between the pixel electrodes 31.

Similar to the first sub-pixels SP1, one organic emission layer 33-2 is commonly formed over two second sub-pixels SP2 adjacent to each other in the second direction. The organic emission layer 33-2 of the second sub-pixels SP2 may have a substantially rhombus shape. In some embodiments, there is no pattern margin between the two adjacent second sub-pixels SP2, and there is only the minimum gap required to substantially prevent a short-circuit between the pixel electrodes 31.

One organic emission layer 33-3 is commonly formed over four third sub-pixels SP3 adjacent to each other in the first and second directions. The shape of the organic emission layer 33-3 of the third sub-pixels SP3 is also substantially a rhombus. In some embodiments, there is no pattern margin between four third sub-pixels SP3 adjacent to each other in the first and second directions, and there is only the minimum gap required to substantially prevent a short-circuit between the pixel electrodes 31.

Similar to the third sub-pixels SP3, one organic emission layer 33-4 is commonly formed over four fourth sub-pixels SP4 adjacent to each other in the first and second directions. The shape of the organic emission layer 33-4 of the fourth sub-pixels SP4 is also substantially a rhombus. In some embodiments, there is no pattern margin between four fourth sub-pixels SP4 adjacent to each other in first and second directions, and there is only the minimum gap required to substantially prevent a short-circuit between the pixel electrodes 31.

As previously described, in some embodiments, the pattern margin is only employed within the pixel PX in the OLED display 100 of the present exemplary embodiment, and no pattern margin is used between pixels PX. Therefore, in the OLED display 100 according to the present exemplary embodiment, the screen luminance and the life-span characteristic of the OLED display 100 can be improved by increasing the light emission area of the sub-pixels SP1 to SP4 when the size of the pixel PX is constrained.

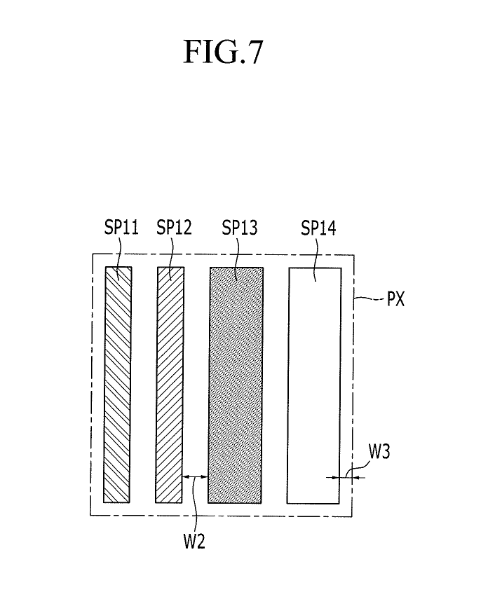

FIG. 7 is a top plan view of a pixel structure of an OLED display according to a comparative example.

Referring to FIG. 7, in the comparative example, each pixel PX includes a first sub-pixel SP11, a second sub-pixel SP12, a third sub-pixel SP13, and a fourth sub-pixel SP14, and they are respectively formed in the shape of a rectangle. A pattern margin is used not only between the sub-pixels SP11 to SP14 in the pixel PX but also between adjacent pixels. In FIG. 7, W2 denotes the width of the pattern margin in the pixel, and W3 denotes the width of the pattern margin in the edge of the pixel. W3 may be about half of W2.

In some embodiments, when the size of the pixel PX is about 150 μm×about 150 μm, the width W2 of the pattern margin in the pixel PX is about 15μ, and the width W3 of the pattern margin in the edge of the pixel PX is about 7.5 μm, the area of the first sub-pixel SP11 and the area of the second sub-pixel SP12 are respectively about 2025 μm² (about 15 μm×about 135 μm), and the area of the third sub-pixel SP13 and the area of the fourth sub-pixel SP14 are respectively about 4050 μm² (about 30 μm×about 135 μm). In this case, a light emission area in the pixel area of about 22,500 μm² is about 12,150 μm² and a non-emission area is about 10,350 μm².

Referring to FIG. 2, when the pixel size and the width of the pattern margin are the same as the comparative example, that is, when W1=W2, the bottom side and the height of the first sub-pixel SP1 are respectively about 70 μm and about 150 μm and the bottom side and the height of the third sub-pixel SP3 are respectively about 35 μm and about 150 μm. The area of the first sub-pixel SP1 and the area of the second sub-pixel SP2 are respectively about 5250 μm², and the area of the third sub-pixel SP3 and the area of the fourth sub-pixel SP4 are respectively about 2625 μm². In this case, a light emission area in the pixel area of about 22,500 μm² is about 15,750 μm² and a non-emission area is about 6,750 μm².

In the pixel structure of the exemplary embodiment, a portion corresponding to the gap between pixel electrodes 31 of two neighboring pixels substantially corresponds to a non-emission area, however, since the width is significantly smaller than the pattern margin, the above calculation of the light emission area and the non-emission area were performed without considering the width of the non-emission area in the edge of the pixel.

Meanwhile, alignment and the shape of the signal lines 11, 21, 22 may be changed according to variation in the shapes of the pixel electrode 31 and the organic emission layer 33. However, although the signal lines 11, 21, and 22 overlap the pixel electrode 31 and the organic emission layer 33, in a front emission type display, the light emission of the organic emission layer 33 may not be influenced by the overlap. Therefore the signal lines 11, 21, and 22 may be formed in the shape of lines crossing each other.

The OLED display according to the present exemplary embodiment can improve the screen luminance and the life-span characteristics thereof by increasing the light emission area of the sub-pixels in a pixel with a fixed size.

While the described technology has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light-emitting diode (OLED) display, comprising:
a plurality of pixels arranged in a first direction and a second direction that cross each other,
wherein each of the pixels comprises:
first and second sub-pixels having a substantially isosceles triangle shape, wherein the second sub-pixel is inverted with respect to the first sub-pixel; and
third and fourth sub-pixels having a substantially right triangle shape, wherein the fourth sub-pixel is inverted with respect to the third sub-pixel.

2. The OLED display of claim 1, wherein the first and second sub-pixels are adjacent to each other in the first direction, and wherein a pattern margin is formed between the first and second sub-pixels in a center portion of the respective pixel.

3. The OLED display of claim 1, wherein the third sub-pixel is adjacent to i) the first sub-pixel in the first direction and ii) an external edge of the respective pixel, wherein a pattern margin is formed between the third and first sub-pixels, wherein the hypotenuse of the third sub-pixel faces the first sub-pixel, wherein the fourth sub-pixel is adjacent to i) the second sub-pixel in the first direction and ii) another external edge of the respective pixel, wherein a pattern margin is formed between the fourth and second sub-pixels, and wherein the hypotenuse of the fourth sub-pixel faces the second sub-pixel.

4. The OLED display of claim 1, wherein two pixels adjacent to each other in the first direction are substantially symmetric with respect to an axis of symmetry that is substantially parallel to the second direction, and wherein two pixels adjacent to each other in the second direction are substantially symmetric with respect to an axis of symmetry that is substantially parallel to the first direction.

5. The OLED display of claim 2, wherein each of the sub-pixels comprises a pixel electrode, an organic emission layer, and a common electrode, and wherein the pixel electrode has substantially the same shape as the corresponding sub-pixel.

6. The OLED display of claim 5, wherein the first sub-pixel faces a first sub-pixel of an adjacent pixel, wherein the two first sub-pixels are adjacent to each other in the second direction, and wherein the organic emission layer is commonly formed over the two first sub-pixels.

7. The OLED display of claim 5, wherein the second sub-pixel faces a second sub-pixel of an adjacent pixel, wherein the two second sub-pixels are adjacent to each other in the second direction, and wherein the organic emission layer is commonly formed over the two second sub-pixels.

8. The OLED display of claim 5, wherein the third sub-pixel faces third sub-pixels of adjacent pixels, wherein the third sub-pixels are adjacent to each other in the first and second directions, and wherein the organic emission layer is commonly formed over four adjacent third sub-pixels.

9. The OLED display of claim 5, wherein the fourth sub-pixel faces fourth sub-pixels of adjacent pixels, wherein the fourth sub-pixels are adjacent to each other in the first and second directions, and wherein the organic emission layer is commonly formed over four adjacent fourth sub-pixels.

10. The OLED display of claim 5, wherein the pixel electrodes of adjacent sub-pixels of adjacent pixels are separated by a gap that is less than the pattern margin.

11. The OLED display of claim 1, wherein the first and second sub-pixels have substantially the same shape and size, and wherein the third and fourth sub-pixels have substantially the same shape and size.

12. The OLED display of claim 11, wherein the size of the third sub-pixel is about half the size of the first sub-pixel.

13. The OLED display of claim 1, wherein one of the first and second sub-pixels is blue and the other is white, and wherein one of the third and fourth sub-pixels is green and the other is red.

14. An organic light-emitting diode (OLED) display, comprising:
a plurality of pixels arranged in first and second directions that cross each other;
wherein each pixel comprises:
first and second sub-pixels each having a substantially isosceles triangle shape; and
third and fourth sub-pixels each having a substantially right triangle shape,
wherein the sub-pixels of two adjacent pixels are substantially symmetric with respect to an axis of symmetry between the two adjacent pixels.

15. The OLED display of claim 14, wherein the second sub-pixel is inverted with respect to the first sub-pixel and wherein the fourth sub-pixel is inverted with respect to the third sub-pixel.

16. The OLED display of claim 14, wherein a pattern margin is formed between the sub-pixels within each of the pixels.

17. The OLED display of claim 16, wherein each of the sub-pixels comprises a pixel electrode, an organic emission layer, and a common electrode, and wherein the pixel electrode has substantially the same shape as the corresponding sub-pixel.

18. The OLED display of claim 17, wherein the pixel electrodes of adjacent sub-pixels of adjacent pixels are separated by a gap that is less than the pattern margin.

19. The OLED display of claim 17, wherein the organic emission layer is commonly formed for at least two adjacent sub-pixels of adjacent pixels.

20. The OLED display of claim 14, wherein the first and second sub-pixels have substantially the same shape and size, and wherein the third and fourth sub-pixels have substantially the same shape and size.
